(19) United States
(12) Patent Application Publication
(10) Pub. No.: US 2012/0293720 A1
(43) Pub. Date: Nov. 22, 2012

(54) TV IMAGE CONTROL SYSTEM VIA INSTANTANEOUS GENERATION OF A BLACK SIGNAL

(76) Inventor: Hector Vicente Francisco Leaño Aceves, Anaheim, CA (US)

(21) Appl. No.: 13/261,368

(22) PCT Filed: Jun. 7, 2010
(86) PCT No.: PCT/MX2010/000052

§ 371 Date: Jul. 18, 2012

(51) Int. Cl. H04N 5/57

(52) U.S. Cl. 348/728; 348/E05.119

(57) ABSTRACT

A television screen control system which generates an instantaneous blanking video signal to reduce power consumption and have control of undesirable images is described in this document. It refers to a system which principally consists of two units, a transmitter unit (1) and a receiver control unit (2). The receiver control unit includes a processing unit (2c) and a video signal selector (2d). In an inoperative mode, the receiving unit allows the output of the input signal of the video source (3) and remains waiting for a switching instruction coming from the emitter unit, by the interface user (2a) or by the programmed automatic interruption. In an operational mode, the control receiving unit generates a blanking video signal through the processing unit and switches the video signal selector to allow the output of the generated blanking signal making the TV displays a dark image without altering the sound signal.

### BACKGROUND OF THE INVENTION

1. Field of the Invention

The present invention relates to a television (e.g., CRT, Plasma, LCD, LED, etc) video signal control system that includes a transmission transducer unit connected via wireless (e.g., Infrared, radio signals, etc) to a receiver unit that could be located inside as part of its embedded circuit or outside of any device that generates, contains or receives video signals (e.g. TV, DVD player, video game console, TV tuner box, etc.), which though a processing unit generates a blank TV video signal to be shown in the TV, reducing the TV power consumption and also give image content control to the user to avoid unwanted scenes.

The user can activate this function any time all the time he wants thought a remote control or through the input button located at the receiver unit, this function is also automatically activated every certain programmed time. The receiver unit can have a on-off switch just in case the user wants to disable the control system.

2. Description of the Prior Art

There are known internal TV sets circuits for blanking and/or blurring the video signal, leaving the audio audible or muting the sound of a received signal but they apply this to cathode ray tube TVs and/or they use a lot of components to get the objective. Samarughi et al. U.S. Pat. No. 5,999,229 is an internal TV control system that has to be embedded in the TV circuit using passive components to suppress the picture and the light emission by the CRT (cathode ray tube), using the audio signal only. The main difference with this invention is that this TV set can be located outside or inside of the TV circuit itself. Another difference is that this device uses a processing unit to generate a video signal in spite of passive components. Also the instantaneous blanking image generation goes active automatically every certain time if is activated, which can be a similar function as the hibernate function in a personal computer.

Porter et al. U.S. Pat. No. 6,337,947 B1 relates a method and apparatus for customized editing (not generating) video and/or audio signals using a plurality of editing parameters which is not an instantaneous function and must be embedded in the TV while the method described in this document is focus in an instantaneous blanking signal no matter the model or the kind of video source.

There is also Peter Vogel U.S. Pat. US 2003/0011716 A1 which is an editing system with a TV commercials detector which reduces the audio and video signal (not generates) every time the system detects a commercial, not when the user wants and again this system must be part of the internal TV circuit.

### SUMMARY OF THE INVENTION

Televisions are present in the vast majority of households in the world, they are ubiquitous that sometimes television in some countries can exceed the number of habitants as in the case of the United States of America, where it exceeds the number of inhabitants with an average of 2.7 TV sets per household (Nielsen, 2006 report). There are more than 320 million televisions in the United States, of which 35 million are only in California, each with an energy consumption between 101 to 361 watts.

According to the California Energy Commission (CEC) and the Pacific Gas & Electric Co. (PG & E Co.), it is estimated that 10% of household electricity bills are due to TV usage, with more than 8 hours and 15 minutes of watching time per day in each household (Nielsen).

LCD sets consume 43% more power than a cathode ray TV, while plasma screens guzzle 3.6 times more. Currently flat panels constitute 30% of the total sets, but they are expected to become the majority by 2011 (CEC, 2009 report).

According to BIGresearch, LLC and The Media Center at the American Press Institute, three quarters of U.S. television viewers read the newspaper while they “watch” TV, a phenomenon known as media multi-tasking (www.americanpressinstitute.org, “Meet Generation C”, study 2004). Furthermore, 51% of TVs are on most of the time even if no one is watching, just for companionship or for listening, as revealed by a Kaiser Family Foundation report on the TV habits of young people up to the age of 18 (available at www.kff.org, study 1999-2009).

Given this background, the problem and the need to lower power consumption demanded by television is latent, that is why we are seeking to solve the problem with this system that generates an instantaneous video blanking image at the time the user directed, leaving the audio signal audible and, in addition, this function is also automatically activated every certain time sending the TV to a low-power mode and can be integrated out or into any device that generates, contains or receives a video signal to be displayed on the TV screen no matter the technology or model of TV.

By using this system, the TV energy consumption drops down to 45 watts which represents a saving of 67%. This means that for each 30 minutes daily usage of the TV along with this system in all household in CA, the energy savings would amount to 356 millions KWh per year. With the finality of reduce the TV power consumption implementing the video blanking image generation, I design this control system using a few components and can be implemented inside or outside of the TV, pretending to protect it through the present solicitude.

### BRIEF DESCRIPTION OF THE DRAWINGS

The specific embodiments and the characteristic details of the present invention TV Image Control System Via Instantaneous Generation of a Black Signal will be clearly described in the next description with reference to the drawings and the following figures in which:

FIG. 1 is a block diagram of the embodiment according to the present invention;

FIG. 2 is a flow chart of an example of programming of the processing unit 2c;

FIG. 3 is an example of the embodiment of the emitter unit 1 circuit means according to the present invention;

FIG. 4 is an example of the embodiment of the receiver control unit 2 circuit means according to the present invention;

FIG. 5 is an example of interaction diagram that shows the interconnection between the present invention and the video generator and TV modules used as external device.

### DETAILED DESCRIPTION OF THE INVENTION

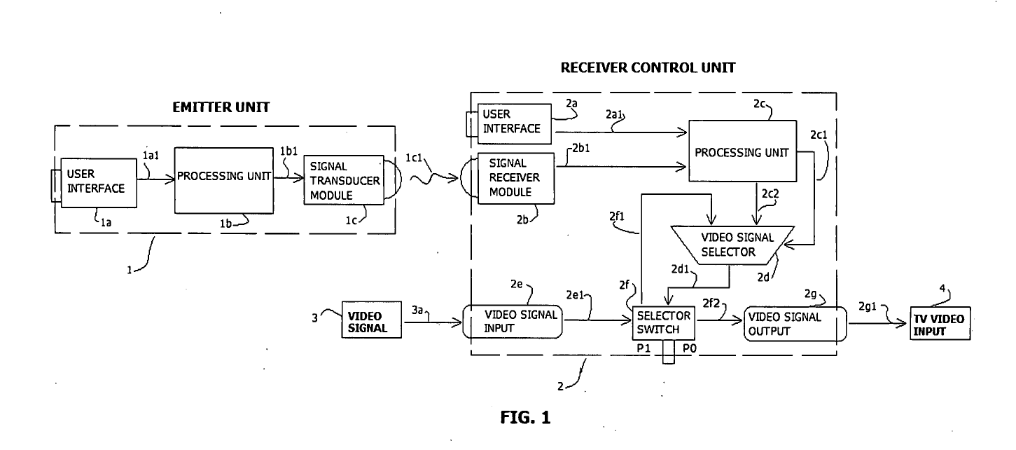

Referring to FIG. 1, the TV Image Control System Via Instantaneous Generation of a Black Signal for reducing the TV power consumption and give control of unwanted content, has inside of the emitter unit 1a user interface 1a used to get the instructions of activation or deactivation of the instantaneous blanking of the TV video signal; the user interface 1a includes a key (not show in figure) that when is pressed generates the signal 1a1 to which the processing unit 1b, the signal transducer module 1c, the signal receiver module 2b and the processing unit 2c will be respond. When this key is pressed, the emitter processing unit 1b also contained inside of the emitter unit 1, generates the signal 1b1 for the signal transducer module 1c when the signal 1a1 is received by the processing unit 1b. The emitter unit 1 also contains a transducer module 1c that receives the signal 1b1 from the processing unit 1b, as a result of the generation of the signal 1a1. The signal transducer module 1c generates a wireless signal 1a for the signal receiver module 2b according to the signal 1b1 coming from the processing unit 1b.

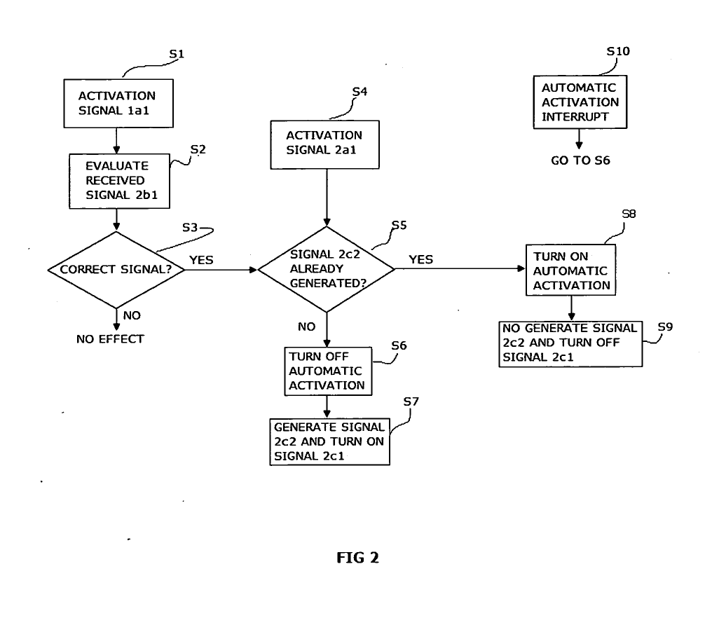

The system also has a receiver control unit 2 which contains a user interface 2a used to receive commands for the activation or deactivation of the instantaneous blanking signal, this user interface 2a includes a key (not show in figure) that when is pressed generates the input signal 2a1 for the processing unit 2c. The receiver control unit 2 also has a receiver module 2b that is in charge of receive the signal 1cl coming from the transducer module 1c to generate the signal 2b1 that is send it to the processing unit 2c. This processing unit 2c is also contained inside of the receiver control unit 2 and receives from both the user interface 2a and the receiver module 2b the signals 2a1 and 2b1 respectively to generate, according to the flow chart of FIG. 2, the output signals 2c1 and 2c2. These generated signals are received by a video signal selector 2d, included inside of the receiver control unit 2, to determine which of the two signals 2c2 and 2f1 is going to be converted to the output signal 2d1. The selection of the video signal selector 2d is controlled by the control output signal 2c1.

The receiver control unit 2 also includes a video signal input 2e, which receives a signal 3a from any video signal source 3 (i.e. DVD player, TV receiver, TV tuner box, video game console, etc.) to create the name signal 2e1. This input signal is connected to a selector switch 2f which depending of the position P0 or P1 is going to make the output signal 2f1. When selector switch 2f is in position P0, the receiver control unit 2 is off and the output signal 2f2 is the same as the signal 3a, which is the same as the signal 2e1. When selector switch 2f is in position P1, the receiver control unit 2 is on and the output signal 2f2 is going to be the same as the signal 2d1, which could be the same as the signal 2f1 or 2c2 depending of the output signal 2c1 of the processing unit 2c. The receiver control unit 2 also contains an output video signal module 2g that receives the signal 2f2 coming from the switch module 2f to form the output signal 2g1.

FIG. 2 illustrate a flow-chart of an example of the software implementation that must be programmed on the processing unit 2c so that the user interface output signal 2a1 from the user interface 2a, the output signal 2b1 of the receiver module 2b and the automatic interruption can activate the signals 2c1 and 2c2 that are need to get the blanking image to be displayed at the TV screen.

Upon activation of the signal 1a1, occurring in step S1, the flow proceeds to step S2 to evaluate the received signal 2b1; the flow proceeds to a decision-step S3 wherein it is checked if the received signal 2b1 is the correct one or not. In case it is not, the signal 2b1 has not effect in the process; otherwise, the flow proceeds to a decision-step S5, wherein it is checked whether the output 2c2 is been already generated or not. In case it is not, the flow branches to a step S6 wherein the automatic activation interruption that generates the output signal 2c2 is turned off; then the flow goes to step S7, wherein the blanking video signal 2c2 is generated and the control signal 2c1 is activated.

If in step S5, the blanking signal 2c2 has been already generated, the flow proceeds to a step S8 wherein the automatic activation interrupt of the blank TV video signal is turned on and the flow branches to a step S9 wherein the output blanking signal 2c2 is not generated and the signal 2c1 is turned off. Upon activation of the signal 2a1 occurring in step S4, the flow proceeds to step S5 to do exactly the same proceeding just described. The parallel step S10 is activated automatically when the time of its internal decreasing counter is over and the flow proceeds to step S6 to do the tasks already described.

### EXAMPLES

In order to give a reference of the TV Image Control System Via Instantaneous Generation of a Black Signal for reducing the TV power consumption and give control of unwanted content, the following figures represent an example and they do not intended to limit the scope of the technology presented in this document.

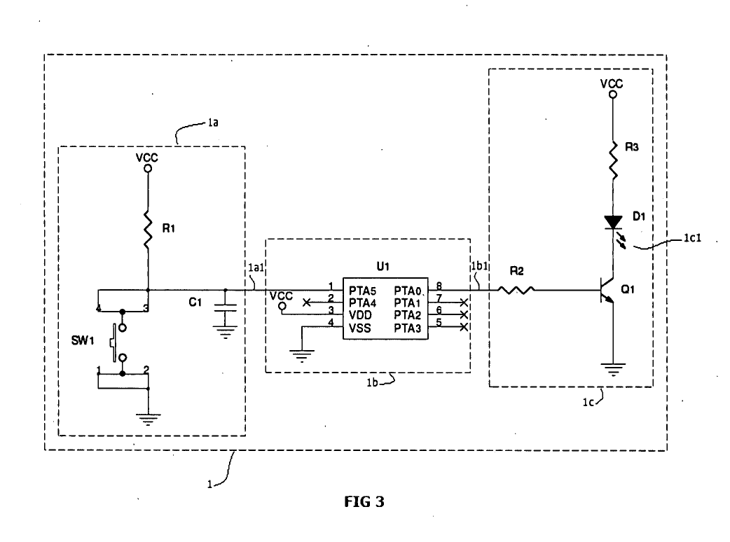

FIG. 3 shows by way of example the circuit of the emitter unit 1 used to activate the instantaneous blanking function of the video signal, already briefly described with reference to preceding FIG. 1. In particular, the circuit includes current-limiting resistors R1, R2 and R3, a key SW1, a capacitor C1, a microcontroller unit U1, a switching npn transistor Q1 and an infrared light emitter diode D1. The user interface 1a includes the key SW1 for the activation of instantaneous video blanking signal, the short-circuiting of this crossing produces the signal 1a1 that will be received by the processing unit 1b. The first end of the resistor R1 is connected to the DC power supply while the second end is commonly connected to 3 points; one to the short-circuiting of the terminals 3 and 4 of the key SW1 where the short-circuiting of the terminals 1 and 2 are grounded; two, to the first terminal of the capacitor C1 which second end is being grounded and, three, is connected in shape of the signal 1a1 to the first input of the processing unit 1b contained inside of the microcontroller unit U1, which is responsible to generate the signal through its output number eight to be connected to the signal transducer module 1c. The signal transducer module 1c includes a resistor R3 which its first end is connected to the DC power supply and its second end is connected to the anode of the infrared light emitter diode D1 which cathode is connected to the collector of the transistor Q1 where the emitted signals from the D1 generate the output signal 1a of the emitter unit 1. This module also includes a resistor R2 which first end is connected to the generated signal 1b1 and second end is connected to the base of the transistor Q1 which the emitter is grounded.

During operation of the emitter unit 1, the short-circuiting of the key SW1 will set the signal 1a1 to logic low (0 V, for example). The microcontroller unit U1 will then start to transmit a square coding signal 1b1 where the values oscillates between logic low and logic high (0.2 V and 2.5 V respectively, for example). When the signal 1b1 is logic high, the transistor Q1 will then start to conduct and the infrared light emitter diode D1 will turned on producing the output signal 1a of the signal transducer module 1c. Otherwise, when the signal 1b1 is a logic low, the transistor Q1 will open the circuit and the infrared light emitter diode D1 will turned off and the output signal 1a will be zero; this will happen at the speed and as many times as directed by the microcontroller U1 through its coded signal 1b1. An appropriate choice of values of the resistors, infrared light emitter diode as well as an appropriate switching transistor, will allow the desired distance to control the processing unit 2c (not shown in this figure).

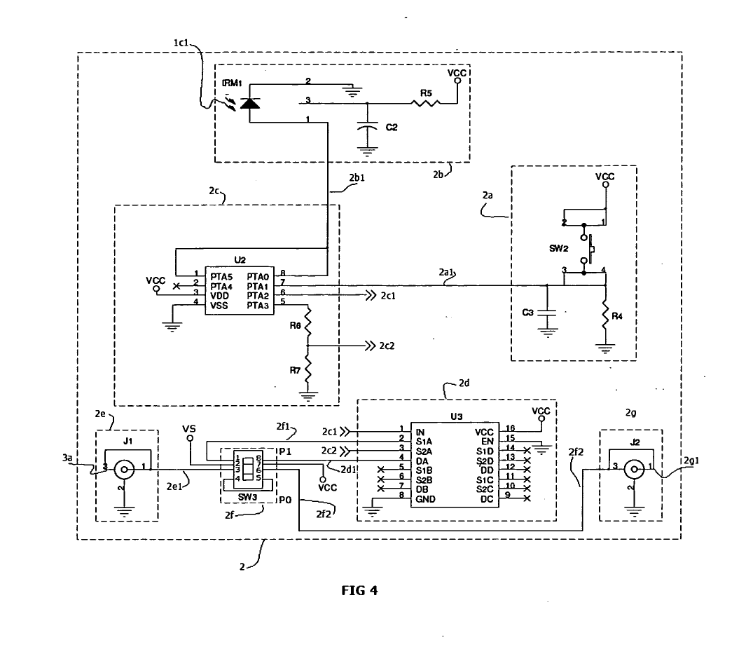

Another example is illustrated in FIG. 4 which shows an internal embodiment of the receiver control unit circuit 2 to generate the blanking video signal already briefly described in FIG. 1. In particular it has an infrared receiver module IRM1, current-limiting resistors R4, R5, R6 and R7, capacitors C2 and C3, a microcontroller unit U2, a key SW2, female RCA connectors J1 and J2, a slide switch SW3 and a video switch U3. The signal 1a coming from the emitter unit 1 is received by the infrared receiver module IRM1 which is located inside of the receiver module 2b and decodes this signal to generate the output signal 2b1 by the first end of the module. The second end is grounded while the third end is connected to both the first end of the capacitor C2 and to the first end of the resistor R5, the second end of the capacitor C2 is grounded and the second end of the resistor R5 is connected to the DC power supply. The processing unit 2c contains a microcontroller unit U2 which receives the signal 2b1 in both the first and eighth ends. The fifth end of the microcontroller unit U2 is connected to the first end of the resistor R6 where the second end is connected to both the first end of the resistor R7, which connects to ground in its second end, and to the third end of the video switch U3, contained inside of the video signal selector 2d through the instantaneous video blanking signal 2c2. The sixth end of the microcontroller unit U2 is connected to the video signal selector 2d in the first end of the video switch U3 through the output signal 2c1. The user interface 2a has the key SW2 as optional way to activate the instantaneous video blanking signal. The short-circuiting of this crossing causes the processing unit 2c to receive signal 2a1. The common connection between the first and second ends of the key SW2 are connected to the DC power supply while the third and fourth ends of the key SW2 are common connected to 3 points; one to the first end of the resistor R4, which its second end is grounded; two, to the first end of the capacitor C3, which its second end is also grounded and three, to the seventh end of the microcontroller unit U2 forming the signal 2a1 generated by the user interface 2a.

The video signal input module 2e contains a RCA female connector J1 that is in charge of receive the signal 3a coming from the video source 3 through the short-circuiting first and third ends while the second end is grounded. The signal 3a received from the RCA female connector J1 is the same as the output signal 2e1 that goes to the third end of the slide switch SW3 located inside of the selector switch 2f. The first end of the slide switch SW3 is connected to the video signal selector 2d in the second end of the video switch U3 through the output signal 2f1. The fourth and fifth ends of the slide switch SW3 are short-circuiting while the sixth end of the slide switch SW3 is the output signal 2f2 and the eighth end receives the output signal 2d1 from the fourth end of the video switch U3. The output signal 2f2 of the slide switch SW3 is connected to the first and third ends of the RCA female connector J2 contained inside of the video signal module output 2g forming the output signal 2g1, while the second end of the RCA female connector J2 is grounded.

The generated TV video blanking signal 2c2 consist in a pulse weight modulation with a fixed period of approximately 64 us and a duty cycle of approximately 4 us. A typical color video signal has a voltage value between 0.3V and 1V approximately where a value of 0.3V corresponds to a black color and 1V corresponds to white color, then the generated signal 2c2 of the microcontroller unit U2 may have a voltage amplitude inside of this rank. This voltage can be fixed with any voltage regulator, i.e., low dropout voltage regulator or diode regulator. In particular, the amplitude of the generated blanking signal 2c2 is fixed to a value of 0.3V with an arrangement of resistor R6 and resistor R7 used as voltage divider. A 75Ω value for resistor R7 is recommended to use for impedance coupling of the receiver control unit 2 with the standard value of the input resistor of the TV video input. An appropriate choice of the resistors values, will allow the desired blank video signal 2c2 to be obtained.

During operation of the receiver control unit 2, the system can respond to three types of activation. First, the activation of the signal 1a1 will set the signal 2b1 to oscillate in a logic low or a logic high according to the signal 1c1 sent by the emitter unit 1 (not shown in this figure); second, the short-circuiting of the key SW2 will set the signal 2a1 to a logic high value (2.5 V, for example); and finally, an automatic interruption with an internal timer, will release the processing unit 2c to accomplish an instruction. The processing unit 2c will stay in low power mode until the activation of any of this three actions occurs, turning the processing unit 2c to active mode and performs to follow the software implementation of flow-chart described with reference to the preceding FIG. 2 and once it finished their tasks it will be back in low power mode to be waiting for a new event. When the processing unit 2c receives the signal 2b1 must check if corresponds to the signal 1a sent it by the emitter unit 1 taking it as a correct signal or if is a different signal it will be read it as an incorrect signal. In the reception of a correct signal 2b1 or in a logic high of the signal 2a1, the processing unit 2c will generate, if has not been already generated, the blanking signal 2c2 and will set the signal 2c1 to a logic high (turn on) or deactivate both signals 2c1 and 2c2 to a logic low (turn off) if the signal 2c1 was already generated. When the control signal 2c1 has a logic low level, the output signal 2d1 of the switch selector 2d will be the same as the signal 2f1, which is the same as the input signal 2e1 coming from the video signal source 3; If the signal 2c1 has a logic high value, the selector switch 2d will select the TV video blanking signal 2c2 as output signal 2d1. When the selector switch SW3 is in position P0 the DC power supply is 0 V and the output signal 2g1 is the same as the input video signal 2e1; In the other hand, when the slide switch SW3 is in position P1 the DC power supply is equal to +3V and the output signal 2g1 is equal to the output signal 2d1 of the video signal selector 2d.

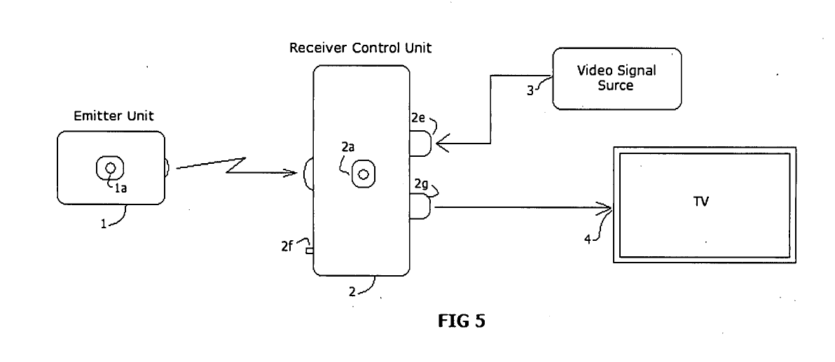

FIG. 5 illustrates an interaction diagram of the receiver control unit 2 to be connected from the video signal input 2e to the output of a video signal source 3 i.e., DVD player or TV tuner box, and from the output video signal output 2g to the input of a TV video input set 4. The emitter unit 1 is used to select via wireless if the TV video input set 4 is going to receive the signal coming from the video signal source 3 or the blanking video signal generated by the receiver control unit 2; alternatively, this can also be selected by the user interface key 2a located in the receiver control unit 2. The TV video input set 4 is going to receive the signal in function of the position of the selector switch 2f already described with reference to the preceding FIG. 4.

The receiver control unit 2 can also be implemented within any device that works as a video signal source 3 as part of its internal circuitry such as a television, DVD player, a video game console, a TV tuner box, etc. To achieve this we eliminate the female RCA connectors J1 and J2 together with the slide switch SW3 including their interconnections and the assembly is done as follows. The receiver control unit 2 is going to be connected in a bypass fashion opening the output video signal terminal circuit of the device where will be implement this system and connect this first point in serial with the signal 211 of the receiving control unit 2 and close the circuit connecting the signal 2d1 coming from the video switch U3 in the second point. The output signal 2d1 depends only of the logic level of the control signal 2c1 coming from the processing unit 2c; if the control signal 2c1 has a logic low level, the output signal 2d1 is the same as the input signal 2f1 coming from the video signal source 3; if the control signal 2c1 has a logic high level, the output signal 2d1 is the same as the blanking signal 2c2 generated by the processing unit 2c. The circuit of the receiving control unit 2 must be powered by any DC power source of +3V available in the device that will have implemented this system control.

What is claimed is:

1. An image control system for television comprising:
a. a dark video signal generation means activated by a remote emitting unit comprising at least one user interface means that activates or turns off the generation of a black color video signal to be displayed through an image reproducing apparatus characterized by having at least one receiving unit that includes at least one electronic circuit, which internally contains a signal receiving module responsible for receiving the signals from said emitting unit and of generating an output signal based on the signal received; and
b. a receiving unit of control to be placed within any video source system complementary to said image reproducing apparatus, or
c. said receiving unit of control to be a standalone gadget that can be placed between said video source system and said image reproducing apparatus

2. an image control system for television according to claim 1 wherein said receiving unit of control comprises said user interface means to activate instantaneously the generation of a dark video signal if the signal has not been generated or turn it off if the signal is already generated

3. an image control system for television according to claim 2, wherein said receiving unit of control comprises said user interface means to activate instantaneously the generation of said dark video signal while keeping on the power of the screen and the sound of said image reproducing apparatus

4. an image control system for television according to claim 1, wherein said receiving unit of control also comprises a processing unit that receives the user interface signals and a signal receiving module in charge of generating two digital signals: a dark video signal and the control signal which selects the output signal of the system; and

5. an image control system for television according to claim 4, wherein said receiving unit of control further comprises a processor of video signal means in charge of receiving said dark video signal and the signal from the video source, and it determines, based on said control signal, the output of the system; and

6. an image control system for television according to claim 1, wherein said receiving unit of control also includes a module, connecting the video input signal, which receives the signal coming from said video source; and

7. an image control system for television according to claim 1, where said video input signal is connected to an interrupting module also included within said receiving unit of control, which, depending on the position, makes the video signals connect and also interrupts the feed of the interrupting unit, turning off the functioning of the system or having said receiving unit of control receive energy so that the receiver can operate; and

8. an image control system for television according to claim 1, wherein said receiving unit of control also contains output connector module, which receives the outgoing video signal coming from the interrupting module and form the output signal of the system

9. an image control system for television according to claim 1 with a dark signal adding system through the instantaneous generation of said dark video signal, wherein the processing of said receiving unit of control generates said dark video signal characterized by a digital signal modulated by pulses at a predetermined work cycle and with a regulated voltage amplitude, which converges to a video processor along with said video input signal to form said output signal of the system

10. an image control system for television according to claim 1, wherein said receiving unit of control is connected electronically on one side by its video input connector to a said source of video and other side is connected by its output signal to the video input of said image reproducing apparatus

11. an image control system for television according to claim 4, wherein said processing unit further comprises a programmed timer that automatically activates said dark video signal after a predetermined period of time when there is no change in volume or channel in said image reproducing apparatus

12. an image control system for television according to claim 4, wherein said processing unit further comprising means for displaying a small blinking window on the image reproducing apparatus when said dark video signal generation means occurs.
